(19) United States
(12) Patent Application Publication
(10) Pub. No.: US 2016/0055944 A1
(43) Pub. Date: Feb. 25, 2016

(54) METHOD OF MANUFACTURING CROSS-LINKED PVC COATED WIRE

(71) Applicant: SUMITOMO WIRING SYSTEMS, LTD., Yokkaichi-city, Mie (JP)

(72) Inventors: Takanori WAKAMATSU, Yokkaichi (JP); Masashi SATO, Yokkaichi (JP)

(73) Assignee: SUMITOMO WIRING SYSTEMS, LTD., Yokkaichi-city, Mie (JP)

(21) Appl. No.: 14/783,212

(22) PCT Filed: Mar. 19, 2014
(86) PCT No.: PCT/JP2014/057452

§ 371 Date: Oct. 8, 2015

(30) Foreign Application Priority Data
Apr. 9, 2013 (JP) 2013-081004

(51) Int. Cl. H01B 13/14

(52) U.S. Cl. CPC H01B 13/145; H01B 13/148

(57) ABSTRACT

Methods for cross-linking a PVC coated wire without using electron beam irradiating equipment are disclosed. The methods include heating an insulating coating after formation of the same to manufacture a cross-linked PVC coated wire in which the outside of a conductor has been coated by the insulating coating, the insulating coating formed from a compound in which an oxidation preventing agent has been added to polyvinyl chloride.

This application is a national stage application of PCT/JP2014/057452, international filing date Mar. 19, 2014, and claims priority to JP 2013-081004, filed in Japan on Sep. 4, 2012, the entire disclosures of which are hereby incorporated by reference in their entirety.

This disclosure relates to methodology for manufacturing a cross-linked PVC coated wire.

### BACKGROUND

With respect to an insulation-coated wire on which PVC (vinyl chloride) is used, there are cases that cross-linking may be used so as to improve heat resistance of the insulating coating.

Japanese Published Patent Application 2011-168697 (P2011-168697A) discloses a method in which a coated wire using vinyl chloride resin as an insulation-coated material is cross-linked with an electron beam.

However, as disclosed in Japanese Published Patent Application 2011-168697 (P2011-168697A), electron beam cross-linking requires expensive cross-linking equipment, such as electron-beam-irradiation equipment and the like. Because of this, with electron beam cross-linking, there was a problem that the production cost naturally increases.

Thus, an object of the present disclosure is to cross-link a PVC coated wire without using electron-beam-irradiation equipment.

A first embodiment of the present disclosure is a method of manufacturing a cross-linked PVC coated wire. In a PVC coated wire, in which an outer peripheral portion of a conductor is coated with an insulating coating that is formed of a compound in which an antioxidant was added to vinyl chloride resin, the insulating coating is heated after being molded.

A second embodiment of the present disclosure is a method of manufacturing a cross-linked PVC coated wire related to the first embodiment, where the insulating coating may be heated at 50-150° C.

A third embodiment of the present disclosure is a method of manufacturing a cross-linked PVC coated wire related to the first or second embodiment, where the insulating coating may be heated for 50 to 300 hours.

According to the method of manufacturing a cross-linked PVC coated wire related to the first embodiment, if insulating coating formed of a compound including vinyl chloride resin is molded and then heated, a cross-linking reaction and a decomposition reaction are caused. The insulating coating formed of the compound to which antioxidant was added can suppress a chain decomposition reaction at the time of heating, due to the antioxidant. Because of this, while the decomposition reaction of the insulating coating is being suppressed, the cross-linking reaction can be promoted. Thereby, a PVC coated wire can be cross-linked without using electron-beam-irradiation equipment.

According to the method of manufacturing a cross-linked PVC coated wire related to the second embodiment, the insulating coating may be heated at 50-150° C., so the cross-linking reaction can be promoted while the decomposition reaction is minimized.

According to the method of manufacturing a cross-linked PVC coated wire related to the third embodiment, the insulating coating may be heated for 50 to 300 hours, so the cross-linking reaction can be promoted more effectively.

### BRIEF DESCRIPTION OF THE DRAWINGS

FIG. 1 is a diagram showing a decomposition reaction due to heating.

FIG. 2 is a diagram showing a reaction of decomposition inhibition by an antioxidant.

FIG. 3 is a diagram showing a dehydrochlorination reaction of vinyl chloride.

FIG. 4 is a diagram showing a cross-linking reaction of a polyene structure.

### DETAILED DESCRIPTION OF EMBODIMENTS

Hereafter, a method of manufacturing a cross-linked PVC coated wire relating to the above-mentioned embodiments will be described. In the method of manufacturing a cross-linked PVC coated wire of the present disclosure, the insulating coating of the PVC coated wire is cross-linked without using electron-beam-irradiation equipment.

The PVC coated wire is provided with a conductor and an insulating coating, which covers an outer peripheral portion of the conductor. That is, the PVC coated wire is manufactured by forming the insulating coating by kneading a granular compound while heating, and extruding the dissolved compound by an extrusion coating device so as to cover the outer periphery of the conductor. Additionally, by cross-linking the PVC coated wire that was extrusion molded, a cross-linked PVC coated wire with improved heat resistance is manufactured.

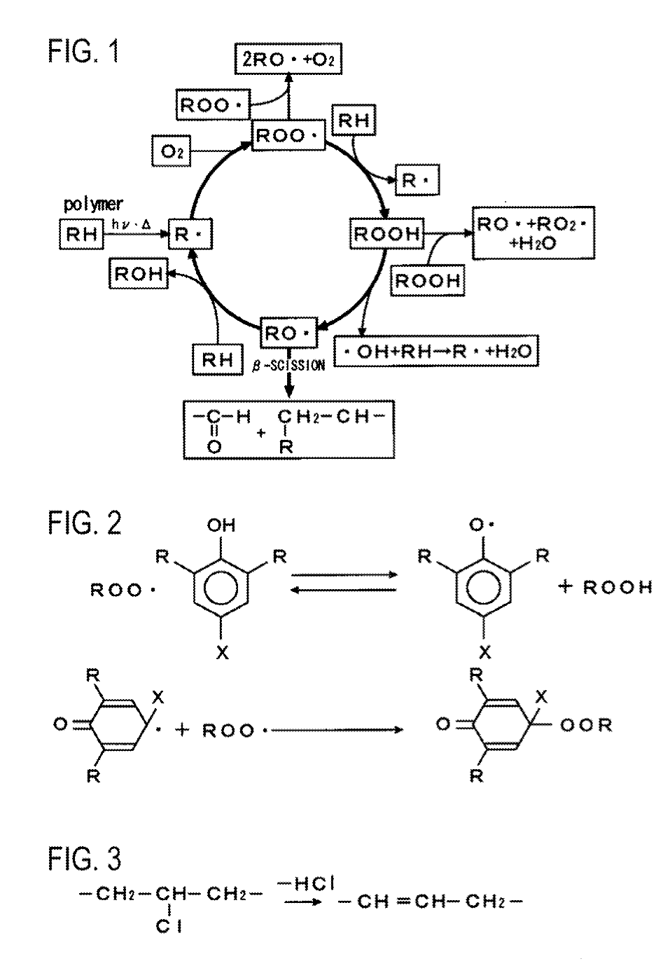

The compound that forms the insulating coating is formed by adding a plasticizer, a filler, a stabilizer, and an antioxidant to vinyl chloride resin. Here, 5-10 parts by weight of antioxidant may be added to 100 parts by weight of vinyl chloride resin. As an antioxidant, phenolic antioxidants, for example, IRGANOX 1010, IRGANOX 1010 FF, IRGANOX 1035, or IRGANOX 1035 FF (IRGANOX (registered trademark) all manufactured by BASF Japan Ltd.) can be used. Then, due to the antioxidant, a decomposition reaction that is caused by radicals shown in FIG. 1 is suppressed (see FIG. 2). That is, as radicals are caused by heat and irradiation of light (ultraviolet rays), a chain decomposition reaction proceeds. Thus, the chain decomposition reaction can be suppressed by removing the radicals with the antioxidant.

The above-mentioned phenolic antioxidants were used as an exemplary antioxidant that is added to vinyl chloride resin for illustration purposes, but the antioxidant is not limited to such phenolic antioxidants. Antioxidants other than the above-mentioned phenolic antioxidants, or a combination thereof, can also be used. Naturally, any suitable antioxidant that can suppress a chain decomposition reaction by antioxidant-action that compensates for the presence of radicals can be used in the methods of the present disclosure.

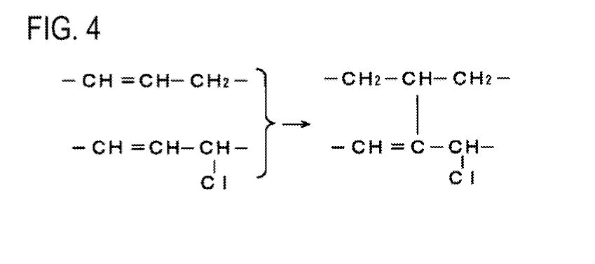

Cross-linking is performed by heating the insulating coating of the PVC coated wire after molding by extrusion from the extrusion coating device. If vinyl chloride resin is heated, a polyene structure is formed by a dehydrochlorination reaction in which chlorine and hydrogen are removed (see FIG. 3). Then, the cross-linking reaction of the formed polyene structure occurs (see FIG. 4).

A heating temperature of the vinyl chloride resin may be set at a temperature at which it is difficult for a chain decomposition reaction to be initiated (i.e., conditions under which it is difficult to generate radicals), and at which a cross-linking reaction is promoted (i.e., at which a dehydrochlorination reaction is promoted). For example, the insulating coating may be heated at 50-150° C. for 50 to 300 hours.

According to some embodiments, in the method of manufacturing a cross-linked PVC coated wire related, if the insulating coating formed of a compound including vinyl chloride resin is molded and then heated, a cross-linking reaction and a decomposition reaction are caused. The insulating coating formed of the compound to which antioxidant was added can suppress, with the antioxidant, a chain decomposition reaction that is caused by radicals at the time of heating. On the other hand, by heating, a polyene structure is formed along with a dehydrochlorination reaction, which causes a cross-linking reaction. Because of this, while the decomposition reaction of the insulating coating is being suppressed, a cross-linking reaction can be promoted. Thereby, a PVC coated wire can be cross-linked without using electron-beam-irradiation equipment. Furthermore, electron-beam-irradiation equipment is not used, so equipment expenses and operating costs can be reduced.

Additionally, the insulating coating may be heated at 50-150° C., so while a chain decomposition reaction is being minimized, the cross-linking reaction can be promoted.

Furthermore, the insulating coating may be heated for 50 to 300 hours, so the cross-linking reaction can be promoted more effectively.

The above description includes various embodiments of the invention of the present disclosure explained in detail, but the above-mentioned description is exemplary in all aspects. The invention is not limited to the exemplary embodiments described above. Additionally, the above-mentioned various modifications can be combined and applied as long as they are not contradictory to each other. Furthermore, countless modifications that are not shown can be assumed without departing from the scope of the invention.

1-3. (canceled)

4. A method of manufacturing a cross-linked PVC coated wire, comprising:
providing a molded PVC coated wire in which an outer peripheral portion of a conductor is coated with an insulating coating that is formed of a compound in which an antioxidant was added to vinyl chloride resin, and heating the insulating coating for 50-300 hours after PVC coated wire is molded.

5. The method of claim 4, wherein
the insulating coating is heated at 50-150° C.
